(19) United States
(12) Patent Application Publication
(10) Pub. No.: US 2022/0079315 A1
(43) Pub. Date: Mar. 17, 2022

(54) Carrying Case and System for Personal Protective Equipment

(71) Applicants: John Burke, JR., Naperville, IL (US); James Banasiak, Lake Villa, IL (US); David Ahmari, Champaign, IL (US)

(72) Inventors: John Burke, JR., Naperville, IL (US); James Banasiak, Lake Villa, IL (US); David Ahmari, Champaign, IL (US)

(21) Appl. No.: 17/519,671

(22) Filed: Nov. 5, 2021

Related U.S. Application Data
(60) Provisional application No. 63/077,074, filed on Sep. 11, 2020.

(51) Int. Cl. A45C 11/00; A45C 13/00; G08B 21/24; G07C 9/00

(52) U.S. Cl. CPC A45C 11/00; A45C 13/005; A45C 2011/002; G07C 9/00896; A45C 2011/007; G08B 21/24

(57) ABSTRACT

A carrying case and system for personal protective equipment. The carrying case includes a housing having a base pivotally secured to a door forming an interior volume, wherein the interior volume of the housing can receive a personal protective equipment, such as a facemask. The base can magnetically fasten to a personal device, such as a smartphone or other mobile electronic device. The door provides access to the interior volume of the housing and is moveable between an open configuration and a closed configuration. A software application is in operable communication with the personal protective equipment and the housing, wherein the software application can send alerts to a user regarding whether the housing contains the personal protective equipment, or the housing is separated from the personal protective equipment after the user has left a home location. The alert system prevents a user from being without the personal protective equipment.

### CROSS REFERENCE TO RELATED APPLICATION

This application claims the benefit of U.S. Provisional Application No. 63/077,074 filed on Sep. 11, 2020. The above identified patent application is herein incorporated by reference in its entirety.

### BACKGROUND OF THE INVENTION

The present invention relates to a carrying case that holds personal protective equipment. The present invention further provides a system for alerting a user if the personal protective equipment is not within the carrying case.

There are various materials and devices for combatting the spread of the viruses and bacteria. Such devices include facemasks for covering the nose and mouth and liquid hand sanitizers. However, the accessibility of these devices greatly determines their effectiveness. Not only must these devices be available for purchase, but they must be easily stored and readily locatable. Personal devices that are typically carried on in a pocket or purse, such as mobile electronic devices, are not designed to efficiently carry a facemask, hand sanitizer containers, or other personal protective equipment (PPE) to protect from an infectious disease, such as COVID-19, influenza and the common cold.

There exists some known art that provides a compartment for storing items, wherein the compartment is integrated onto clothing, helmet, or case, and designed for a specific type of heavy-duty usage, such as at a construction site, or a critical medical device, such as an inhaler or an epinephrine auto-injector. These devices are limited in their scope of use and ease for daily use because they are not capable of accommodating different objects other than for which they are designed. In addition, the devices fail to integrate into the daily life of a user as needed to protect from infectious disease due to their bulkiness and limited applicability to much of the population.

Further, it is important to isolate some PPE from other stored items within a common case. Some people do not want to contaminate credit cards, keys, cellphones, and the like by exposing those items to used PPE. Therefore, there exists a need to provide a device that has a separate compartment isolated from other common objects used daily. Some of these known devices include carrying cases designed to receive a smartphone, carry credit cards and other related items. However, they fail to provide any type of storage capability that can store infectious disease prevention equipment, as well as keep the equipment isolated.

Some devices in the known art provide a thin case or sleeve that is attachable to a rear side of a smartphone. However, inserts within the sleeves are not designed to store a PPE or provide a fully integrated solution to prevent infection. In addition, these sleeves are not enclosed and are exposed to the exterior, which can lead to exposure and contamination of the items stored therein. Therefore, there is a need for a carrying case having a fully enclosed compartment for storing PPE.

Existing devices fail to provide a fully integrated system capable of storing various PPE that is securable to a personal mobile electronic device. The existing devices therefore fail to promote widespread and mobile PPE usage, storage, personal utilization protocols, encouragement of adhering to health and safety protocols, and potential smartphone integration.

The present invention provides a carrying case that is mountable to a mobile electronic device and designed to safely store and dispense various PPE. The carrying case is adapted to removably secure to the electronic device, providing protection for the device and ease of access for the PPE, such as hand sanitizer and a facemask. The present invention ensures that facemasks and other types of PPE are readily available to the user, thereby encouraging and enable ease of daily use.

In light of the devices disclosed in the known art, it is submitted that the present invention substantially diverges in design elements and methods from the known art and consequently it is clear that there is a need in the art for an improvement for a carrying case and system for personal protective equipment. In this regard the instant invention substantially fulfills these needs.

### SUMMARY OF THE INVENTION

In view of the foregoing disadvantages inherent in the known types of carrying cases and systems for personal protective equipment now present in the known art, the present invention provides a new carrying case and system wherein the same can be utilized for retaining a facemask therein and providing alerts to a user, while securing to a personal device, such as a cellphone.

It is an objective of the present invention to provide an embodiment of the carrying case and system for personal protective equipment comprising a housing having a base pivotally secured to a door, wherein a rear side of the base is configured to secure to a personal device, such as a mobile electronic device. The base and door form an interior volume when in a closed configuration, wherein the interior volume is adapted to store a personal protective equipment, such as a facemask.

It is another objective of the present invention to provide an embodiment of the carrying case and system for personal protective equipment further comprising a facemask, wherein the case and the facemask are each configured to transmit information to a software application installable on the user's mobile electronic device. The information transmittable includes usage data of the facemask, sanitizer liquid, and the like. Further, the application is configured to provide reminders and alerts to the user regarding the PPE usage when leaving or entering a home or public location and replacement of the PPE as needed. In some embodiments, the information can be sharable with a secondary device, such as a watch adapted to monitor health characteristics.

It is therefore an object of the present invention to provide a new and improved carrying case and system for personal protective equipment that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the housing of an embodiment of the carrying case in an open configuration.

FIG. 2 shows an alternate perspective view of the housing of an embodiment of the carrying case in an open configuration.

FIG. 3 shows a top planar view of the housing of an embodiment of the carrying case in an open configuration.

FIG. 4 shows a side view of the housing of an embodiment of the carrying case in an open configuration.

FIG. 5 shows a planar view of the housing of an embodiment of the carrying case in a closed configuration.

FIG. 6 shows a side view of the housing of an embodiment of the carrying case in a closed configuration.

FIG. 7 shows a block diagram of an embodiment of the carrying case and system.

FIG. 8 shows a planar view of an embodiment of the carrying case and system mounted to a mobile electronic device.

FIG. 9 shows a perspective view of an embodiment of the carrying case and system mounted to a mobile electronic device.

### DETAILED DESCRIPTION OF THE INVENTION

Reference is made herein to the attached drawings. For the purposes of presenting a brief and clear description of the present invention, the preferred embodiment will be discussed as used for storing personal protective equipment that is securable to a mobile electronic device. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment”, “first embodiment”, “second embodiment”, or “third embodiment” does not necessarily refer to the same embodiment.

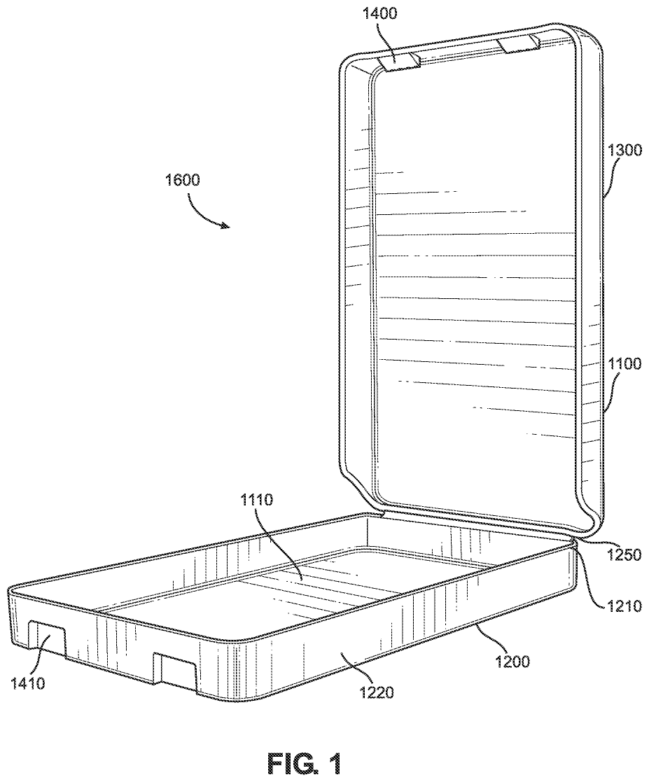

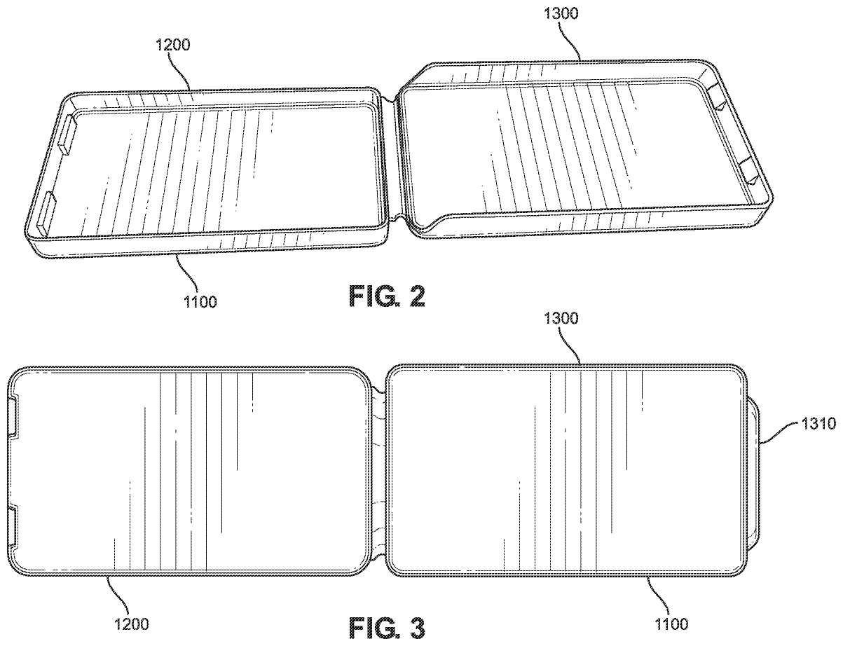

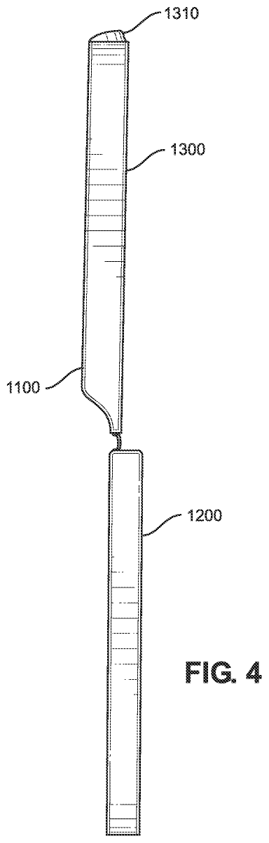

Referring now to FIGS. 1-4, there are shown various views of the housing of an embodiment of the carrying case for personal protective equipment in an open configuration. The carrying case 1000 comprises a housing 1100 having an interior volume 1110 and a base 1200, wherein the base 1200 is configured to secure to a personal device and the interior volume 1110 is configured to receive a personal protective equipment. In the illustrated embodiments, the personal device is a smartphone. However, in alternate embodiments, the personal device is an object intended to be carried on the user's person or in a bag or purse, such as another mobile electronic device, a wallet, etc. In the illustrated embodiments, the personal protective equipment discussed is a facemask, wherein the housing 1300 is intended to receive a soft-bodied, foldable mask within the interior volume 1110. However, in alternate embodiments, the personal protective equipment is any item that can be received by the housing such as a container of liquid hand sanitizer, keys, gloves, earplugs or earphones, and the like.

In the illustrated embodiment, the housing 1300 comprises a rectangular shaped cross section. However, in alternate embodiments, the housing comprises a shape that corresponds to the shape of the personal device to which it is intended to attach. In the illustrated embodiment, the housing 1300 comprises rounded edges to provide for a smooth, unobstructed transition into and out from the user's clothing or bag. In the illustrated embodiment, the housing 1300 is composed of a rigid, plastic material. However, in alternate embodiments, the housing 1300 is composed of any suitable durable material. In some embodiments, the housing comprises one or more cutouts within the base that are configured to align with buttons or cameras of a smartphone to which the housing is intended to attach so as not to interfere with the function of the smartphone. In some embodiments, the housing includes antibacterial and antiviral material disposed on an exterior thereof to prevent further transmission of any bacteria or virus.

In the illustrated embodiment, the base 1200 comprises an entirely planar exterior surface so as to rest flush against a mating planar surface of the personal device. In the illustrated embodiment, the base 1200 is composed of a material adapted to magnetically secure to the personal device. In alternate embodiments, a fastener is disposed on the exterior surface of the base and adapted to secure to an existing phone case or directly to a rear side of the smartphone. In some embodiments, a layer of adhesive is disposed over the entire exterior surface of the housing, wherein the layer is protected by a sheath. When the sheath is removed from the base, the adhesive layer will be exposed for use. In some embodiments, the rear side of the base 1200 comprises a sidewall extending opposite from a front side of the base and adapted to enclose a smartphone or other personal device. In alternate embodiments, a ringlet fastener is disposed along a corner of the housing and configured to secure to a backpack or purse. In this way, the carrying case 1000 can secure directly to an alternate personal device if the user does not have a smartphone. The fastener is any suitable mechanism adapted to secure the housing to the personal device.

In the illustrated embodiment, a door 1300 is pivotally secured to the base 1200, wherein the door 1300 is configured to provide access to the interior volume 1110 of the housing. The door 1300 is moveable between an open configuration and a closed configuration, wherein the closed configuration the interior volume is closed forming a seal to prevent access to the personal protective equipment to prevent contamination thereof by isolating the interior volume from any exterior contaminants. In the illustrated embodiment, the door 1300 and base 1200 form a clamshell shaped housing 1100 attached to one another via a living hinge 1250. The clamshell shape of the housing 1100 allows a user to rotate the door 1300 at least approximately 180 degrees from the base 1200 to have unobstructed access to the interior volume 1110. The door 1300 rotates along a horizontal axis and is secured to a first side 1210 of the base 1200, wherein the first side 1210 comprises a length shorter than a length of an adjacent lateral side 1220. However, in other embodiments, the door 1300 is disposed in other positions on the housing such as a sidewall or front side thereof. In some embodiments, the door 1300 is disposed along the lateral side 1220 and configured to rotate about a vertical axis. In other embodiments, the door is slidably attached to the base and, in alternate embodiments, the door is removably attached from the base.

In the illustrated embodiment, a tab 1310 is disposed along an edge of the door 1300 to assist a user in separating the door 1300 from the base 1200 when in a closed configuration. The tab 1310 extends from an exterior of the door sidewall to form a handle. In the illustrated embodiment, the tab 1310 is molded or monolithic with the door.

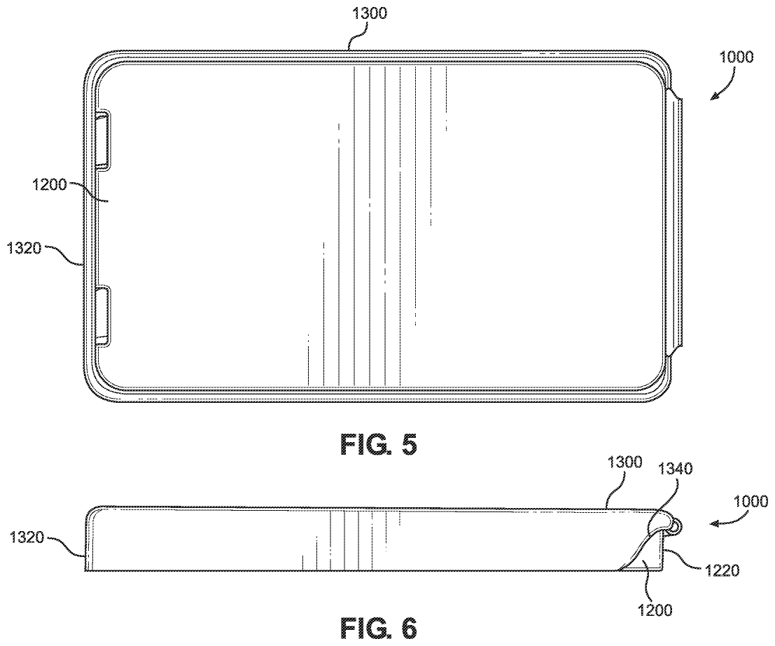

Referring now to FIGS. 5 and 6, there is shown a planar view and a side view of the housing of an embodiment of the carrying case in a closed configuration, respectively. In the illustrated embodiment, in the closed configuration, the base 1200 and the door 1300 are disposed in a stacked configuration, wherein a sidewall 1320 of the door 1300 encloses a sidewall 1220 of the base 1200. In the closed configuration, the sidewall 1320 of the door 1300 is parallel to the sidewall 1220 of the base 1200.

In the illustrated embodiment, the carrying case comprises a latching fastener having a tapered latch 1400 configured to engage with a corresponding recess 1410 (shown in FIG. 1). The locking fastener is configured to maintain the housing 1100 in the closed configuration until a user disengages the fastener. A pair of latches 1400 are disposed on the interior of the sidewall 1320 of the door along the free end 1305, wherein the free end opposes the hinge. A pair of recesses are disposed opposite the latches on the exterior of the sidewall 1220 of the base 1200, along a free end. The recesses each comprise a rectangular shaped cross section having a depth substantially equivalent to a depth of the top of the latch. Each latch extends from the sidewall 1320 and tapers toward the base 1200 such that when the latch passes over the sidewall 1220 of the base 1200, the latch enters the recess. An upper end of the recess serves as a barrier to the latch by preventing the latch from being easily removed from the recess without force. The top portion of the latch catches the upper end of the recess until a user applies force to the tab to disengage the latch from the recess. In alternate embodiments, the latching fastener is replaced by any fastener configured to maintain the housing in a closed configuration, such as female and male fasteners, magnetic fasteners, hook and loop fastening material, snap fasteners, other types of latching fasteners, and the like.

In the illustrated embodiment, the rear end of the door 1300, which is opposite to the free end, comprises a cutout 1340. The cutout 1340 comprises a substantially triangular shape and is intended to prevent interference between the door 1300 and the edge of the base 1200 when the door 1300 is transitioning between the open and closed configurations.

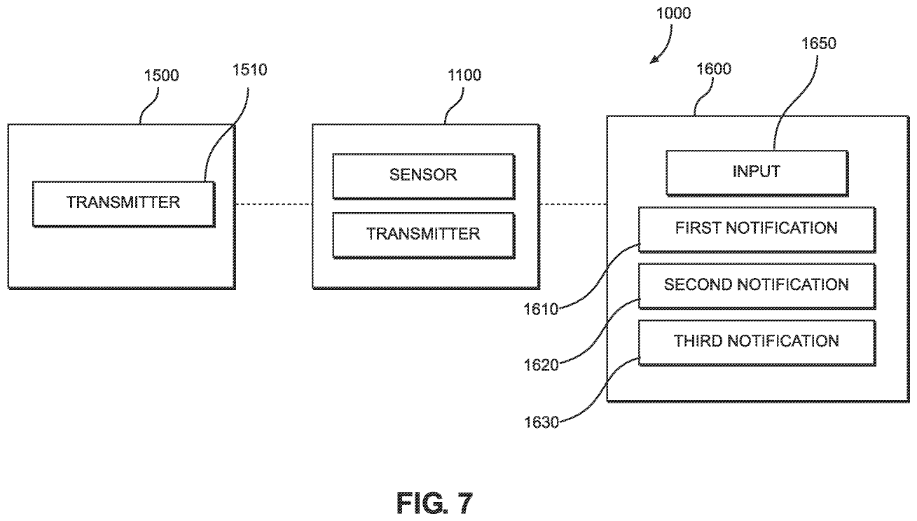

Referring now to FIGS. 7, there is shown a block diagram of an embodiment of the carrying case and system. The present invention comprises a transmitter 1510 disposed on the personal protective equipment, which in the illustrated embodiment is the facemask 1500. In the illustrated embodiment, the transmitter 1510 is a radio-frequency identification (RFID) tag, wherein the facemask 1500 is configured to transmit information to a software application 1600 installable on the user's smartphone or other electronic device. In embodiments wherein the facemask 1500 includes a transmitter 1510, the facemask 1500 is adapted to be machine washed without damage thereto. In some embodiments, a transmitter is attachable to other personal protective equipment via any suitable fastener, such as an adhesive or sewing. In other embodiments, any suitable wireless transmitter is used, such as Bluetooth technology, infrared communication, and the like.

The system 1000 is configured to provide alerts to the user, as well as generally inform the user of usage of the personal protective equipment. In some embodiments, a sensor 1120 and transmitter 1110 are disposed within the housing 1100, wherein the sensor is configured to detect the presence of the personal protective equipment and the transmitter sends the information to the application on the smartphone. The sensor 1120 is any suitable sensor such as a proximity, ultrasonic, capacitive, photoelectric, inductive, or magnetic sensor, and the like. For example, the information communicated to the user through the application includes notification whether the housing is empty via the sensor 1120. In some embodiments, the sensor 1120 is positioned on the interior of the housing to detect the proximity of an object therein.

In some embodiments, the system 1000 is configured to send a first notification 1610 to the application 1600 on the smartphone if the user and facemask 1500 are over a predetermined distance from each other. The user location is determined by a GPS locator or similar device disposed within the user's smartphone. This is beneficial in that the system 1000 can alert the user to prevent leaving his or her facemask 1500 at home or at another location upon departure with his or her smartphone. The application 1600 comprises an interface having one or more inputs 1650 that allows a user to enter and customize the distance in which the system 1000 should send an alert.

In some embodiments, the application comprises a second notification 1620 if the user nears the maximum range of the facemask 1500 position detection by the smartphone. For example, the second notification 1620 can be set between 5 to 20 feet from the maximum distance range via an input option on the interface.

In some embodiments, the application 1600 is configured to detect whether the user has left his or her house and is in public without removing the facemask 1500 from the housing 1100. In this situation, the system is configured to provide a third notification 1630 as a reminder to don the facemask 1500 when entering a public location or a general reminder to bring the housing 1100 having the PPE when leaving the home. In this embodiment, the application comprises a home location input that allows a user to set a home location such that the application detects when the user is a predetermined distance away from the home location. The third notification 1630 is based on the distance that the user enters within the application as the maximum radius to be considered at the home location until a public location is detected. In the illustrated embodiments, each notification or alert is adapted to be enabled or disabled by the user.

In some embodiments, the user can enable communication and data-sharing through the application 1600 with wearable devices and other health related applications that are adapted to monitor health characteristics, such as body temperature and heart rate.

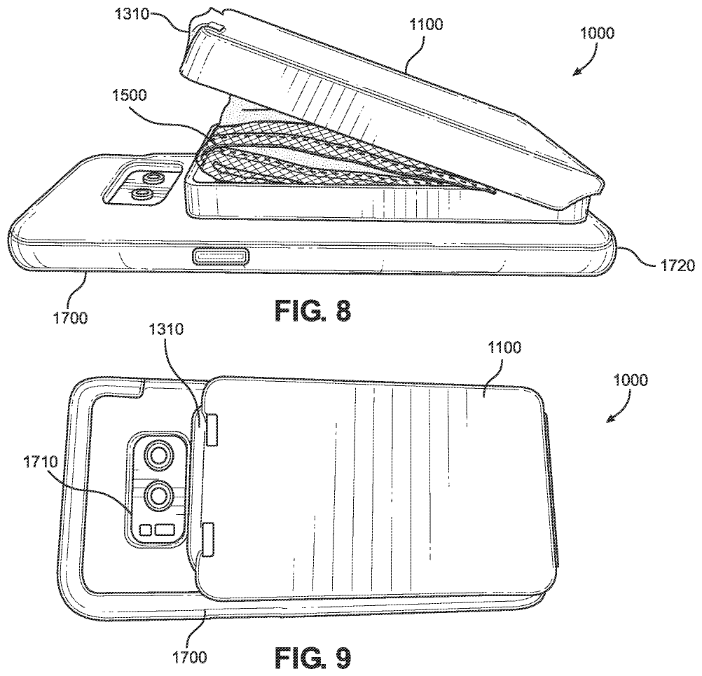

Referring now to FIGS. 8 and 9, there is shown a perspective view and a planar view of an embodiment of the carrying case and system mounted to a mobile electronic device, respectively. In operation, the exterior of the base of the housing 1100 is fastened directly to a personal device, such as a smartphone 1700. In the illustrated embodiment, the housing 1100 is sized to fit between a lower end of the smartphone 1700 and a camera lens 1710. In this embodiment, a width of the housing 1100 in the closed configuration is between 2.4 inches and 2.7 inches, such that the housing will not extend beyond the lateral sides of the smartphone 1700. A length of the housing 1100 is between 3.5 inches to 4.5 inches. In other embodiments, the length and width of the housing comprise any suitable measurement as long as the housing remain between the lateral sides and lower end 1720 of the smartphone and beneath the camera lens 1710 thereof. In the illustrated embodiment, the free end of the base 1200 and the door 1300 are adjacent to the upper end of the smartphone, whereas the hinged end is adjacent to the lower end 1720 of the smartphone 1700.

A user transitions the housing 1100 between the open and closed configurations by grasping the tab 1310 to release or fasten the locking fastener. As the user applied outward force or pulls on the tab 1310, the latches are released from the recesses. Once released, the user removes the facemask 1500 or replaces the facemask 1500 within the housing 1100 as needed.

The application comprises an alert system embedded in a non-transitory computer readable medium comprising logic, that when executed, causes the alert system to send a first notification alert if the personal protective equipment and the housing are over a predetermined maximum distance from one another. In the illustrated embodiment, the application comprises a first input configured to allow a user to set the predetermined maximum distance of the first notification. In some embodiments, the logic is further configured to send a second notification if the personal protective equipment and housing are within a predetermined range of the maximum distance, wherein a second input is disposed within the application interface configured to allow a user to set the predetermined range of the second notification. In other embodiments, the logic is further configured to send a third notification if the housing is outside of a home location and the personal protective equipment is not detected within the housing, wherein the application comprises a third input configured to allow a user to set the home location of the third notification. In alternate embodiments, the logic is further configured to send a fourth notification alert if the personal protective equipment is detected as not within the housing. In some embodiments, the application comprises only one notification alert, all notification alerts, or some number of notification alerts therebetween. In some embodiments, there is only one input configured to receive all the input information for each notification alert, whereas other embodiments comprise a distinct input disposed on the application interface for each type of notification alert.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A carrying case and system for personal protective equipment, comprising:
a housing having an interior volume and a base, wherein the base is configured to secure to a personal device and the interior volume is configured to receive a personal protective equipment;
a sensor disposed within the housing and configured to detect if the personal protective equipment is located within the interior volume;
a transmitter disposed on the personal protective equipment and configured to send information to an application disposed on a portable electronic device;
wherein the application comprises an alert system embedded in a non-transitory computer readable medium comprising a logic, that when executed, causes the alert system to:
send a first notification alert if the personal protective equipment and the housing are over a predetermined maximum distance from one another.

2. The carrying case of claim 1, wherein the personal protective equipment is a facemask removably disposed within the interior volume of the housing.

3. The carrying case of claim 1, further comprising a door pivotally secured to the base, wherein the door is configured to provide access to the interior volume of the housing.

4. The carrying case of claim 3, wherein the door and the base form a clamshell configuration and wherein the door is moveable between an open configuration and a closed configuration when the housing is secured to the personal device.

5. The carrying case of claim 3, further comprising a locking fastener having a latch disposed on an interior sidewall along a free end of the door of the housing and a corresponding recess disposed on an exterior sidewall of a free end of the base of the housing, wherein a closed configuration the locking mechanism prevents the door from releasing from the base without force applied from a user.

6. The carrying case of claim 3, wherein the door extends an entire width of the housing.

7. The carrying case of claim 4, wherein the closed configuration a sidewall of the door encloses a sidewall of the base.

8. The carrying case of claim 4, wherein the open configuration the door is configured to rotate substantially 180 degrees from the base, about a horizontal axis.

9. The carrying case of claim 1, wherein the housing is composed of a heat resistant material configured to protect the personal protective equipment positioned within the housing.

10. The carrying case of claim 1, wherein the transmitter is an RFID tag embedded within the personal protective equipment and configured to be machine washable.

11. The carrying case of claim 1, wherein the application comprises a first input configured to allow a user to set the predetermined maximum distance of the first notification alert.

12. The carrying case of claim 1, wherein the logic is further configured to send a second notification alert if the personal protective equipment and housing are within a predetermined range of the maximum distance.

13. The carrying case of claim 1, wherein the logic is further configured to send a third notification alert if the housing is outside of a home location and the personal protective equipment is not detected within the housing.

14. The carrying case of claim 13, wherein the logic is further configured to send a fourth notification alert if the personal protective equipment is detected as not within the housing.

15. The carrying case of claim 12, wherein the logic is further configured to send a third notification if the housing is outside of a home location and the personal protective equipment is not detected within the housing.

16. The carrying case of claim 15, wherein the logic is further configured to send a fourth notification alert if the personal protective equipment is detected as not within the housing.

17. A carrying case for personal protective equipment, comprising:
a housing having an interior volume formed by a base and a door pivotally secured to one another, wherein the door is moveable between an open configuration and a closed configuration;
wherein the base is secured to the door via a living hinge, forming a clamshell configuration;
wherein an exterior side of the base is planar and configured to secure to a smartphone;
wherein the door is configured to provide access to the interior volume of the housing such that in the closed configuration, the interior volume is fully enclosed;
wherein the closed configuration, a sidewall of the door encloses a sidewall of the base such that access to the interior volume is prevented;
wherein the open configuration the door is configured to rotate substantially 180 degrees from the base, about a horizontal axis.

18. The carrying case of claim 17, wherein the door is adapted to rotate away from an upper end of the smartphone when secured thereto.

19. The carrying case of claim 18, further comprising a locking fastener having a latch disposed on an interior sidewall along a free end of the door of the housing and a corresponding recess disposed on an exterior sidewall of a free end of the base of the housing, wherein a closed configuration the locking mechanism prevents the door from releasing from the base without force applied from a user.
